(19) United States
(12) Patent Application Publication
(10) Pub. No.: US 2016/0318360 A1
(43) Pub. Date: Nov. 3, 2016

(54) DUAL TRAILER SYSTEM FOR PICKUP TRUCK, AND CONVERTIBLE TRAILER ADAPTABLE THERETO

(71) Applicant: 9306-6801 QUÉBEC INC., Quebec (CA)

(72) Inventors: Sylvain Harvey, Quebec (CA); Christian Pichette, Quebec (CA)

(21) Appl. No.: 15/204,613

(22) Filed: Jul. 7, 2016

Related U.S. Application Data
(63) Continuation-in-part of application No. 14/797,786, filed on Jul. 13, 2015.
(60) Provisional application No. 62/023,356, filed on Jul. 11, 2014.

(51) Int. Cl. B60D 1/48; B62D 53/08

(52) U.S. Cl. CPC B60D 1/481; B62D 53/0842

(57) ABSTRACT

The dual trailer system adapted to be towed by a pickup truck having a fifth wheel on a bed thereof, the dual trailer system comprising: a lead trailer having a wheeled frame with a gooseneck-mounted kingpin at a front end thereof, for coupling to the fifth wheel of the pickup truck, and a lead trailer fifth wheel at the rear of the lead trailer; a tail trailer having a wheeled frame with a tail trailer kingpin at a front end thereof, the primary trailer hitch having a kingpin matching the lead trailer fifth wheel for attachment thereto. The lead trailer can have an extendible portion at the rear to allow selectively extending and retracting the fifth wheel for use together with or independently from the tail trailer, and the tail trailer can also be usable independently from the lead trailer such as by way of an additional coupler which can also be provided on an extendible frame.

### CROSS-REFERENCE TO RELATED APPLICATIONS

This application is a continuation-in-part of U.S. application Ser. No. 14/797,786 filed Jul. 13, 2015 by applicant, which claimed priority to U.S. application 62/023,356 filed Jul. 11, 2014, the contents of both these applications being hereby incorporated by reference.

### BACKGROUND

While many trailer variations have been provided for the transport of merchandise via semi-trailer tractor trucks, there remain unaddressed needs. In particular, it was desired to increase the capacity of trailers adapted to be towed with a pickup truck.

### SUMMARY

This specification discloses a dual trailer system which can be specifically adapted for towing with a pickup truck. Moreover, a design of a lead trailer and a design of a tail trailer is provided by which each trailer of the dual trailer system can be used independently of the other.

Pickup trucks are light duty trucks having an enclosed cab and an open load area (in this the load is cargo) at the rear. The open cargo area has a bed, one side wall extending along each side of the bed to a given height (lower than the height of the cab), and a tailgate at the rear. Light-duty trucks are a class vehicles having a payload capacity of less than 4000 pounds. Pickup trucks are widely used vehicles, and are owned by both individuals and corporations. In accordance with one aspect, there is provided a dual trailer system adapted to be towed by a pickup truck having a fifth wheel on a bed thereof, the dual trailer system comprising: a lead trailer having a wheeled frame with a gooseneck-mounted kingpin at a front end thereof, for coupling to the fifth wheel of the pickup truck, and a lead trailer fifth wheel at the rear of the lead trailer; a tail trailer having a wheeled frame with a tail trailer kingpin at a front end thereof, the primary trailer hitch having a kingpin matching the lead trailer fifth wheel for attachment thereto.

In accordance with another aspect, there is provided a convertible trailer having a wheeled frame with a kingpin at a front end thereof, the kingpin being securable to a fifth wheel coupling; and a secondary trailer coupler.

In accordance with another aspect, there is provided a lead trailer for use with a pickup truck and a tail trailer in a dual trailer system, the lead trailer comprising a wheeled frame having a gooseneck-mounted kingpin at the front end thereof, for coupling to the truck, and a fifth wheel coupling at the rear.

Many further features and combinations thereof concerning the present improvements will appear to those skilled in the art following a reading of the instant disclosure.

### DESCRIPTION OF THE FIGURES

In the figures,

FIG. 1 is a side elevation view of a first example of a dual trailer system for a pickup truck;

FIG. 2 is a side elevation view of a second example of a dual trailer system;

FIGS. 3A, 3B are top and rear views, respectively, of a slidable fifth wheel assembly provided at the rear of a lead trailer of a dual trailer system; and

FIGS. 4A and 4B are side and top plan views, respectively, of a slidable coupler.

### DETAILED DESCRIPTION

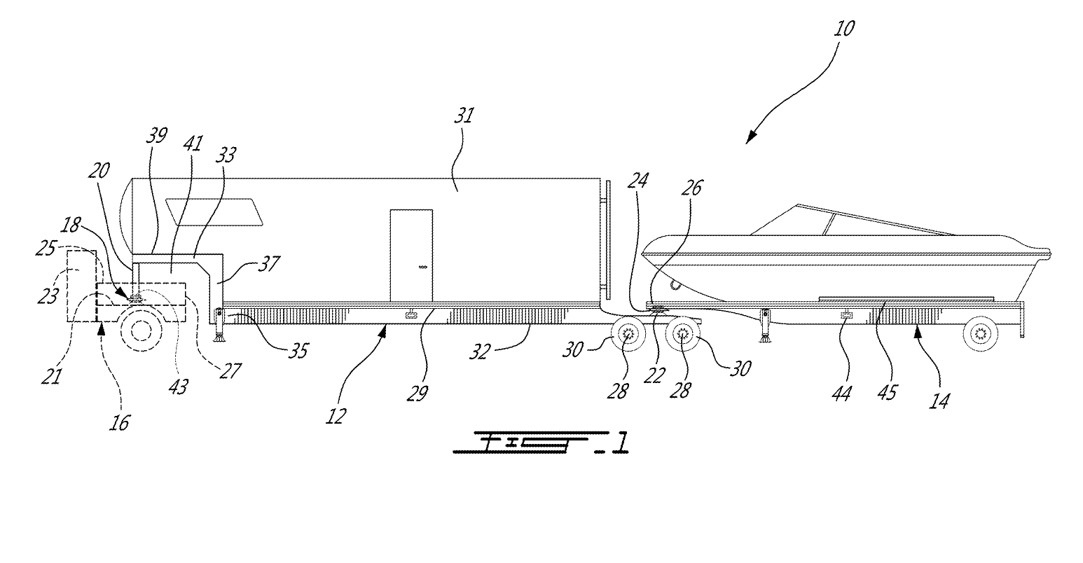

FIG. 1 shows an example of a dual trailer system 10. The dual trailer system 10 generally includes a lead trailer 12 at the front, and a tail trailer 14 at the rear, with the tail trailer 14 shown removably coupled to the lead trailer 12.

In this example, the dual trailer system 10 is specifically adapted to be mounted to a pickup truck 16 having a fifth wheel coupling 18 mounted to its bed 21. As well known by persons of ordinary skill in the art, the pickup truck 16 has a cab 23, two side walls 25, one on each side of the bed 23, and a tailgate 27 at the rear. The side walls 25 are lower in height than the height of the cab 23. the lead trailer 12 has a load area 29 having a load 31. In this case, the load 31 is a mobile home, but it will be understood that the lead trailer 12 can be adapted for other forms of loads in alternate embodiments. The lead trailer 12 is coupleable to the fifth wheel of the pickup truck 16 via a king pin 20. More specifically, the lead trailer 12 has a cantilevered arm, or gooseneck 33, at the front end 35 thereof, the gooseneck 33 being made integral to the wheeled frame 32 of the lead trailer 12. The gooseneck 33 having a first portion 37 extending upwardly from the front end 35 of the wheeled frame to a given height, above the height of the side walls 25 of the pickup truck 16. The gooseneck 33 has a second portion 39 extending more or less horizontally from the top of the first portion 37, in the front direction. The gooseneck 33 forms a clearance area 41 below the second portion 39 and in front of the first portion 37, which allows the lead trailer 12 to clear the side walls 25 of the pickup truck 16 when the pickup truck 16 turns around road corners. A mast 20 is provided which extends downwardly from the distal end of the gooseneck to a kingpin 43 at its lower, free end. In the figure, the kingpin 43 is shown engaged with a fifth wheel coupling 18 of the pickup truck 16. The lead trailer 12 has a fifth wheel coupling 22 at a rear thereof. The tail trailer 14 has a kingpin 24 protruding downwardly from a front end thereof and being configured to be coupleable to the lead trailer 12 via the fifth wheel coupling 22 provided at the tail of the lead trailer 12.

In the example shown in FIG. 1, the lead trailer 12 is embodied in the form of a mobile home or travel trailer, whereas the tail trailer 14 is used to tow a boat. Accordingly, the load of the tail trailer is a boat, whereas the load of the lead trailer is the mobile home. The tail trailer also has a load area 45 adapted to receive the boat.

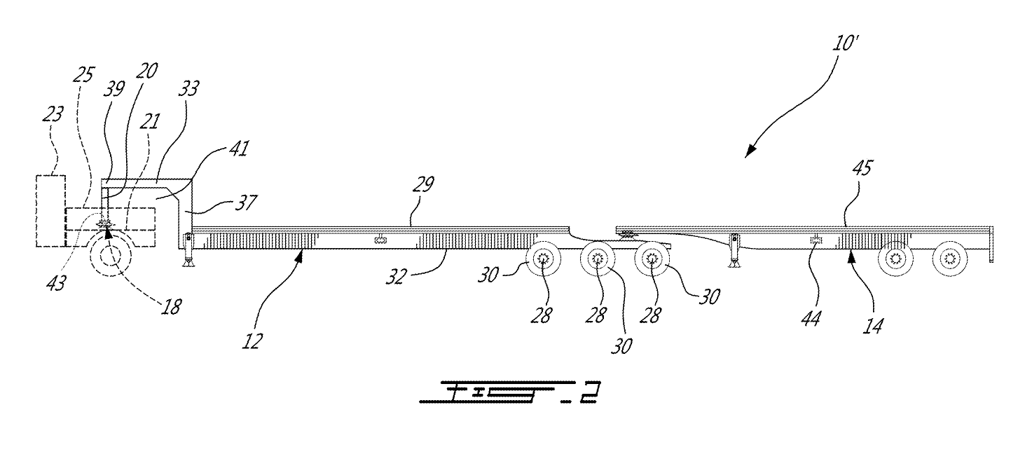

FIG. 2 shows an alternate example of a dual trailer system 10′. In the example shown in FIG. 2, the load areas of both the lead trailer 12 and the tail trailer 14 are flat beds designed to receive a load in the form of cargo (not shown). It will also be noted that the trailers in FIG. 2 have a different number of axles than the trailers in FIG. 1. Many other variants are possible.

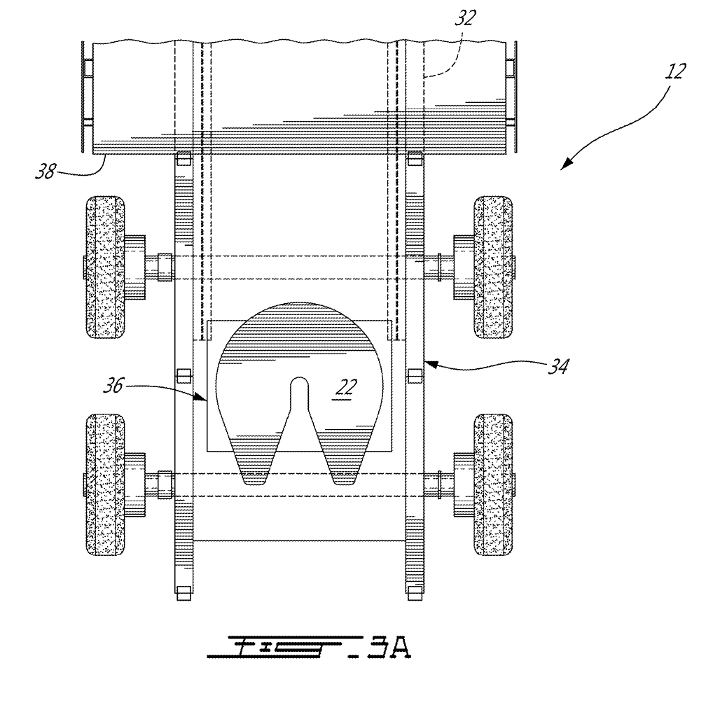

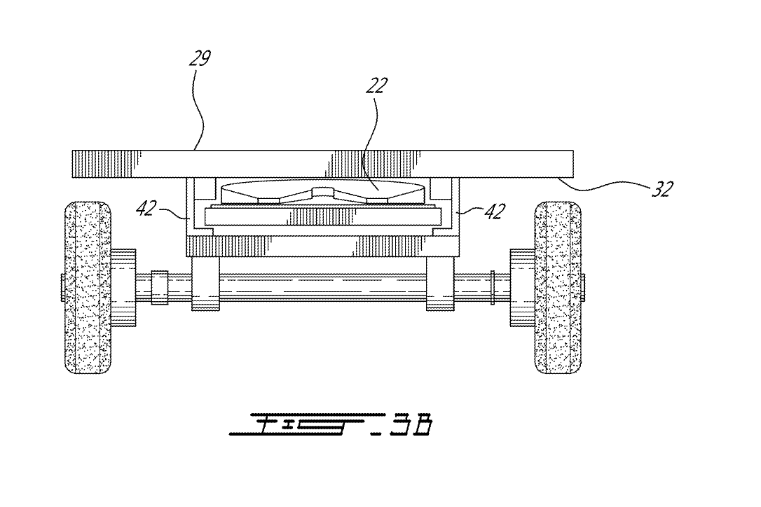

In the example shown in FIG. 1, the axles 28 of the lead trailer 12 are fixed relatively to the lead trailer 12. In an alternate example, in order to allow more flexibility in using the lead trailer 12 independently from the tail trailer 14, the axles 28 of the lead trailer can be mounted on a carriage being slidably mounted to a main frame 32 of the lead trailer 12 in a manner to be extendible selectively extendible and retractable relative to the main frame 32. Such an example is shown in greater detail in FIGS. 3A and 3B, where, the wheels 30 of the lead trailer 12 are provided on an extendible frame portion 34, more particularly a slidable fifth wheel assembly 36 in this example, the extendible frame portion 34 being slidable relative to the main portion 32, or bed portion 38, of the lead trailer 12. The extendible frame portion 34 is shown extended in FIG. 3A, and appropriately locked into the extended position (e.g. with lock pins), in which configuration the fifth wheel 22 of the lead trailer 12 is exposed above the wheels 30 and axles 28 to receive the king pin 24 of the tail trailer 14.

Indeed, when using the lead trailer 12 alone, i.e. without the tail trailer 14, the extendible frame portion 34 extending past the bed portion 38 of the lead trailer 12 can be associated to a length of the lead trailer 12 which reduces maneuverability without adding significant use. Henceforth, retracting the extendible frame portion 34 within the main portion 32 of the lead trailer 12 can reduce the overall length of the lead trailer 12 when used alone without significantly affecting its functionality. The axles 28, their suspension, and the fifth wheel 22 can be mounted to the extendable frame portion 34 slidingly mounted to the main frame 32 of the lead trailer 12 via elongated l′ or ‘C’ shaped beams 42 and thus be slidable therealong while being lockable into a given longitudinal position by suitable locks.

In the example shown in FIG. 1, the kingpin 24 of the tail trailer 14 does not have a gooseneck and is fixed relatively to the tail trailer 14. The tail trailer 14 can be provided with more flexibility in using it independently from the lead trailer 12 by providing it with an additional, secondary trailer coupler 44 which can be specifically adapted to coupling to a ball-type two hitch on a towing vehicle. In this specific embodiment, to avoid interference of the secondary coupler 44 when the kingpin 24 (or primary coupler) is used, the secondary coupler 44 is slidably mounted to the wheeled frame of the tail trailer 14 in a manner to be extendible therefrom and retractable therein.

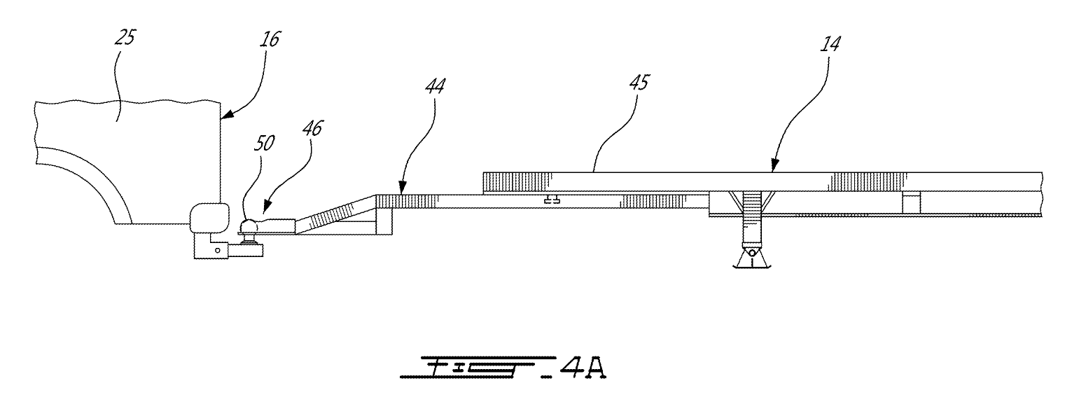

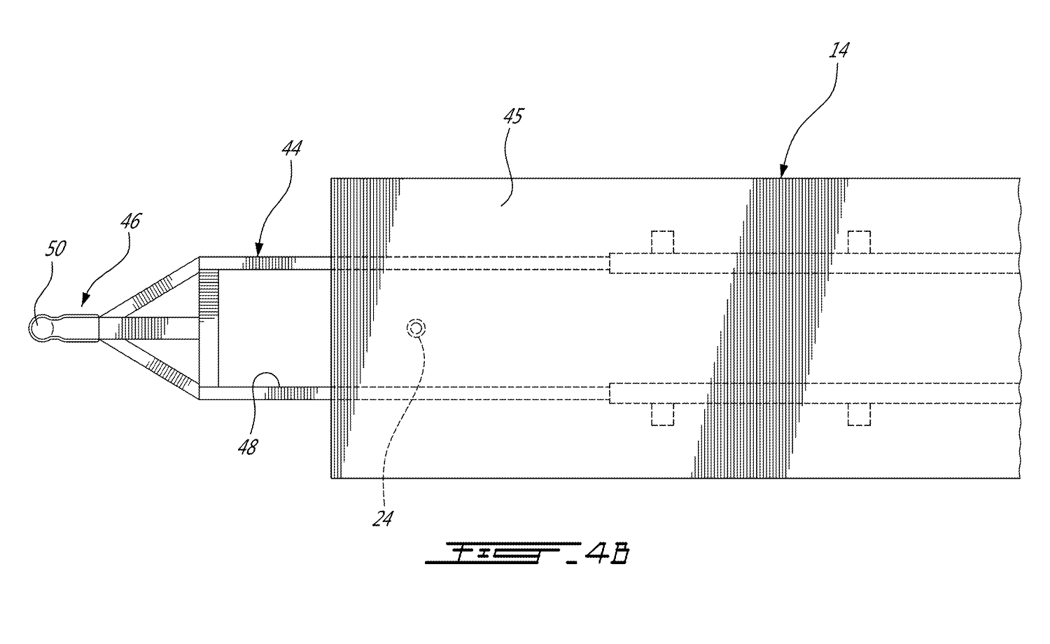

An example embodiment having a retractable/extendible coupler are provided in FIGS. 4A and 4B where the secondary trailer coupler 44 is made part of a slidable frame portion 46 which has an elongated aperture 48 in the center. The kingpin 24 forming the trailer coupler, which will be referred to herein as ‘primary’ for convenience and independently of its intended relative frequency of use with the ball-type coupler, extends across the elongated aperture 48. Henceforth, the kingpin 24 does not interfere with the sliding operability of the slidable frame portion 46 and associated secondary trailer coupler 44. Moreover, when the slidable frame portion 46 is retracted, the secondary trailer coupler 44 does not interfere with the mating ability of the kingpin 24 with the fifth wheel 22 of the lead trailer 12.

In this example, the secondary tow hitch has a tow ball coupler 50, though it will be understood that another type of tow hitch can be used in alternate embodiments, as deemed practical in view of specific embodiments.

As can be understood, the examples described above and illustrated are intended to be exemplary only. The scope is indicated by the appended claims.

What is claimed is:

1. A dual trailer system adapted to be towed by a pickup truck having a pickup fifth wheel made integral to a bed thereof, and two side walls each extending to a given height along a corresponding side of the bed, the dual trailer system comprising:
a lead trailer having a wheeled frame with a load area, a lead trailer fifth wheel at the rear of the lead trailer, a gooseneck at a front end of the lead trailer, the gooseneck extending above a height of the side walls of the light-duty pickup truck, and a mast extending downwardly from a front end of the gooseneck and having a kingpin at a lower end thereof, the kingpin being configured for coupling to the fifth wheel of the pickup truck, and;
a tail trailer having a wheeled frame with a load area, a tail trailer kingpin at a front end of the tail trailer, the tail trailer kingpin matching the lead trailer fifth wheel for attachment thereto.

2. The dual trailer system of claim 1 wherein the tail trailer further comprises a secondary trailer coupler adapted for attachment directly to a hitch of a towing vehicle, allowing use of the tail trailer independently from the lead trailer.

3. The dual trailer system of claim 2 wherein the secondary trailer coupler is slidably mounted to the wheeled frame of the tail trailer and thereby selectively extendible for use directly coupled to the towing vehicle and retractable for avoiding interference with the tail trailer kingpin when coupling the tail trailer kingpin to the lead trailer fifth wheel.

4. The dual trailer system of claim 3 wherein the kingpin of the tail trailer extends across an elongated longitudinal opening provided in a slidable frame portion of the secondary trailer hitch and does not interfere with the sliding of the slidable frame portion.

5. The dual trailer system of claim 3 wherein the secondary trailer coupler has a tow ball coupler attachable to a tow ball of the towing vehicle.

6. The dual trailer system of claim 1 wherein the load area of at least one of the lead trailer and the tail trailer has a flat bed adapted to receive cargo.

7. The dual trailer system of claim 1 wherein wheels of the lead trailer are provided on an extendible frame portion, the extendible frame portion being slidably extendible from a main frame portion of the lead trailer and lockable in the extended position for coupling with the kingpin of the tail trailer, and slidably retractable within the main frame portion of the lead trailer and lockable into the retracted position to reduce the overall length of the lead trailer when the lead trailer is used independently from the tail trailer.

8. A convertible trailer having a wheeled frame with a load area, a kingpin at a front end thereof, the kingpin being securable to a fifth wheel coupling; and a secondary trailer coupler.

9. The convertible trailer of claim 8 wherein the secondary trailer coupler is slidably mounted to the wheeled frame and thereby extendible for use directly coupled to a towing vehicle and retractable for towing of the convertible trailer by a leading trailer via the kingpin.

10. The convertible trailer of claim 9 wherein the kingpin of the convertible trailer extends across an elongated longitudinal opening provided in a slidable frame portion of the secondary trailer hitch and does not interfere with the sliding of the slidable frame portion.

11. The convertible trailer of claim 9 wherein the secondary trailer coupler has a tow ball coupler attachable to a tow ball of a towing vehicle.

12. The convertible trailer of claim 1 wherein the load area has a flat bed adapted to receive cargo.

13. A lead trailer for use with a pickup truck and a tail trailer in a dual trailer system, the lead trailer comprising a wheeled frame with a load area, a lead trailer fifth wheel at the rear of the lead trailer, a gooseneck at a front end of the lead trailer, the gooseneck extending above a height of the side walls of the light-duty pickup truck, and a mast extending downwardly from a front end of the gooseneck and having a kingpin at a lower end thereof, the kingpin being configured for coupling to the fifth wheel of the pickup truck.

14. The lead trailer of claim 13 wherein the gooseneck-mounted kingpin is provided at a front end of a main portion of the wheeled frame, and the wheels and fifth wheel coupling are provided on an extendible frame portion at the rear of the wheeled frame, the extendible frame portion being slidably extendible from the main portion of the lead trailer for coupling with a kingpin of the tail trailer, and slidably retractable within the main portion of the lead trailer to reduce the overall length of the lead trailer when the lead trailer is used independently from the tail trailer.

15. The lead trailer of claim 14 wherein the extendible frame portion further comprises a suspension of axles of the wheels.

16. The lead trailer of claim 14 wherein the extendible frame portion is slidingly mounted to the main portion of the wheeled frame via elongated C-shaped or L-shaped members made integral to the main portion of the frame and oriented longitudinally relative to the length of the lead trailer.

17. The lead trailer of claim 13 wherein the load area has a flat bed adapted to receive cargo.
